(19) United States
(12) Patent Application Publication
(10) Pub. No.: US 2003/0017848 A1
(43) Pub. Date: Jan. 23, 2003

(54) Personalizing electronic devices and smart covering

(76) Inventors: G. Eric Engstrom, Kirkland, WA (US); Tyrol R. Graham, Seattle, WA (US)

Correspondence Address: SCHWABE, WILLIAMSON & WYATT, P.C., 10260 SW GREENBURG ROAD, SUITE 820, PORTLAND, OR, 97223, US

(21) Appl. No.: 10/087,098

(22) Filed: Mar. 1, 2002

Related U.S. Application Data
(60) Provisional application No. 60/306,326, filed on Jul. 17, 2001.

(51) Int. Cl. H04B 1/38

(52) U.S. Cl. 455/558; 455/550; 455/575; 455/90; 455/419

(57) ABSTRACT

An electronic device such as a mobile phone, a personal digital assistant, a palm sized personal computer, a media player or a game console, is provided with an interchangeable covering having visual representation of a theme, and an electronic component embedded therein having data and/or programming instructions for non-visual representation of the theme. Additionally, a coupler, such as a contact or a contactless, facilitates exchange of the data and/or programming instructions between the electronic device and the electronic component embedded within the interchangeable covering. The exchanged data personalizes the electronic devices to the predetermined theme. As a result, personalization of electronic devices to a theme may be accomplished more efficiently.

### RELATED APPLICATIONS

The present application is a non-provisional application of provisional application No. 60/306,326, filed on Aug. 17, 2001, having the same title, and claims priority to said provisional application.

### FIELD OF INVENTION

The invention relates to the field of personalizing electronic devices. More specifically, the invention relates to the personalization of mobile electronic devices.

### BACKGROUND OF THE INVENTION

With the proliferation of electronic devices, especially mobile electronic devices, such as, mobile phones, hand-held personal computers, and so forth, these devices have gained the status of personal appliances to a person. As a result, increasingly, users desire to personalize these devices. For example, in addition to a wide variety of body casing colors, interchangeable faceplates of various colors and artistic designs are available for a variety of mobile phones to allow the users to have even greater choices providing different physical appearances to their own devices. Additionally, a variety of non-standard screen-savers and ring tones can be downloaded into the devices to further personalize the devices. Similarly, hand-held personal computers and personal digital assistants also come in various colors, with various screen savers and wallpapers.

These approaches to personalization suffer from a number of disadvantages. First, they are disjoint. Typically, a user may go to a mall or an online e-commerce site to shop and purchase, e.g. a faceplate with design and/or color that is of interest to the user. Then, the user may go online to web sites to search and look for a custom ring tone or a screen saver of interest to the user. It is the user's responsibility to choose and combine the appropriate hardware, i.e. faceplate design/color, with the software behavior, i.e. custom ring tone etc. to create a total personality. The process is cumbersome for many users, especially for the more novice users, as the proliferation of mobile electronic devices reaches more and more users. Moreover, the approaches do not facilitate quick and timely changes to the personality to be taken on by the mobile electronic devices. These shortcomings apply equally to personalization of other electronic devices, such as game consoles. Thus, an improved approach to provide users with better personalization experience is desired.

### BRIEF DESCRIPTION OF DRAWINGS

The invention is illustrated by way of example and not by way of limitation in the figures of the accompanying drawings, in which like references indicate similar elements and in which:

FIG. 1 illustrates an exemplary mobile electronic device, upon which one embodiment of the invention may be practiced;

FIGS. 2A & 2B illustrate one embodiment of the invention utilizing a mobile phone of FIG. 1;

FIG. 3 illustrates an alternate embodiment for integrating an electronic component with interchangeable coverings of mobile electronic devices to personalize the mobile electronic device;

FIGS. 4A & 4B illustrate another example of a mobile electronic device, upon which one embodiment of the invention may be practiced;

FIG. 5 illustrates an internal view of a contactless interchangeable PDA covering for a PDA;

FIG. 6 illustrates an example of personalizing a mobile electronic device, in accordance with one embodiment of the invention;

FIGS. 7A & 7B illustrate an architectural view of a mobile electronic device, which is intended to be representative of a mobile phone and a PDA, and an interchangeable covering, which is to be representative of an interchangeable covering; and

FIGS. 8A & 8B illustrate the operational flow of the relevant aspects of the enhanced interchangeable coverings for mobile electronic devices, in accordance with one embodiment of the invention.

### DETAILED DESCRIPTION OF THE INVENTION

For ease of understanding, the present invention will be primarily described in the context of wireless mobile phones and personal digital assistants. However, it is anticipated that the present invention may be practiced on a wide range of other electronic devices, including but are not limited to game consoles, media players, and other devices of the like. Accordingly, references to wireless mobile phones and personal digital assistants in the description to follow are merely illustrative, and are not to be read as limitations to the claims.

In the following description, various aspects of the invention will be described. However, it will be apparent to those skilled in the art that the invention may be practiced with only some or all aspects of the invention. For purposes of explanation, specific numbers, materials and configurations are set forth in order to provide a thorough understanding of the invention. However, it will also be apparent to one skilled in the art that the invention may be practiced without the specific details. In other instances, well-known features are omitted or simplified in order not to obscure the invention.

Parts of the description will be presented in terms of operations performed by a computer system, using terms such as data, flags, bits, values, characters, strings, numbers and the like, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through mechanical and electrical components of the computer system, and the term computer system include general purpose as well as special purpose data processing machines, systems, and the like, that are standalone, adjunct or embedded.

Various operations will be described as multiple discrete steps in turn, in a manner that is most helpful in understanding the invention, however, the order of description should not be construed as to imply that these operations are necessarily order dependent. In particular, these operations need not be performed in the order of presentation.

In various embodiments of the invention, electronic components are integrated with interchangeable coverings of mobile electronic devices. This integration facilitates improved personalization of the mobile electronic devices and allows for the changing of personalizing themes of the mobile electronic device to be easy and quick.

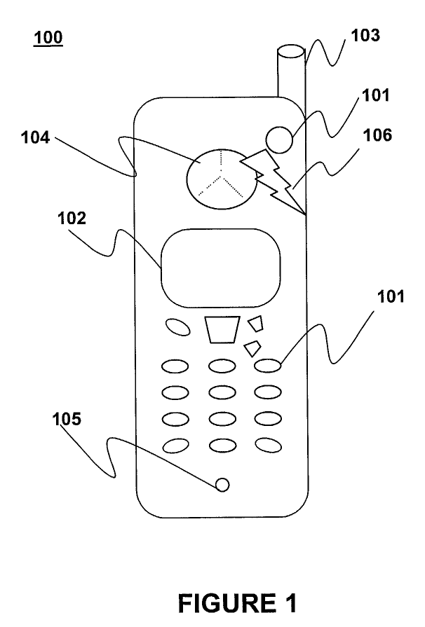

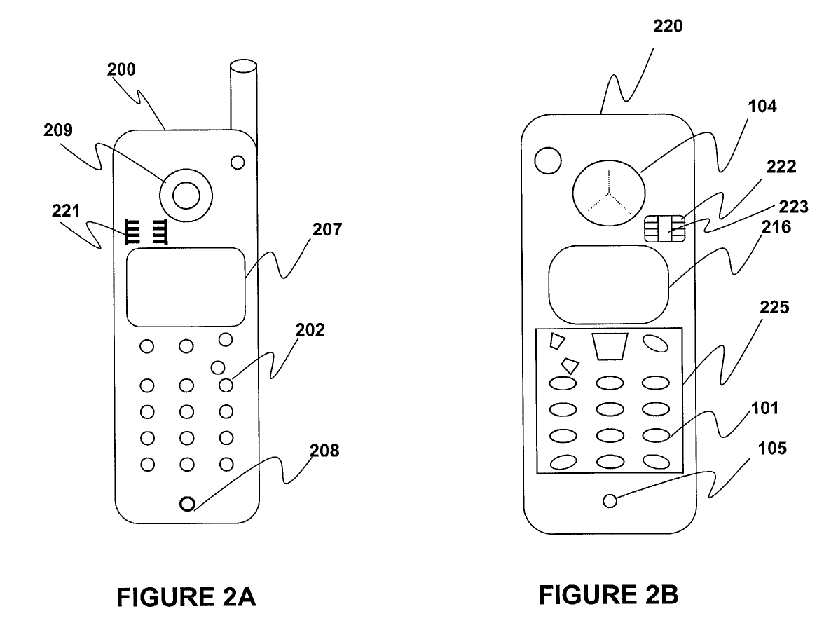

FIG. 1 illustrates an exemplary electronic device, upon which one embodiment of the invention may be practiced. Shown in FIG. 1, is a mobile phone 100 with its various components. These components may include a number of keys 101 for various user functions, a display 102 having a graphical user interface, an antenna 103 for receiving and transmitting signals wirelessly, an area for sound transmission 104, and an area for sound reception 105. Additionally, shown in FIG. 1, is a decoration 106, on the surface of the mobile phone 100, which may be on an interchangeable covering 220 (FIG. 2B), incorporated with the teachings of the present invention. This decoration 106 is utilized to easily and quickly provide the mobile phone with visually perceivable attributes of a personality. This decoration 106 may be in the form of a decorative image integrated in the material making up the surface of the mobile phone 100, a decorative color of the mobile phone 100, a series of decorative images adhering to the surface of the mobile phone 100, and so forth. Accordingly, a user may acquire a number of decorations 106 to the personal tastes of the user (not shown), and be able to quickly switch from one to the other.

FIGS. 2A & 2B illustrate one embodiment of the invention utilizing the mobile phone 100 of FIG. 1. Shown in FIG. 2B, the decorated interchangeable covering 220 of the mobile phone 100 is removed, revealing an internal view of the interchangeable covering 220. Shown in FIG. 2A is the exposed mobile phone 200, with its interchangeable covering 220 removed, exposing buttons (or electrical contacts) 202 that are pressed by a keypad 225 formed with keys 101 molded onto the interchangeable covering 220. Shown in FIGS. 2A & 2B, the orientation of the exposed mobile phone 200 and the interchangeable covering 220 is such that the right side of the exposed mobile phone 200 corresponds to (or engages with) the left side of the interchangeable covering 220, and the left side of the exposed mobile phone 200 corresponds to (or engages with) the right side of the interchangeable covering 220. Additionally shown are a display, such as, a liquid crystal display (LCD) 207, a microphone 208, and a speaker 209. The LCD 207 corresponds to a screen area 216 to display a graphical user interface 102. The speaker 209 and the microphone 208 correspond to the area for sound transmission 104, and the area for sound reception 105, respectively on the interchangeable covering 220, for sound to pass through.

In accordance with the illustrated embodiment of the present invention, interchangeable covering 220 includes electronic component 223 embedded in the interchangeable covering 220 having data and/or programming instructions for personalizing various behavioral or non-visual aspects of the personality of exposed mobile phone 200. In accordance with one embodiment, the data and/or programming instructions provide a customized ring tone complementary to an aspect of a personalizing theme conveyed by the design and color of faceplate 220. Additionally, for the embodiment, the data and/or programming instructions further include address specifications designating locations on a network where additional data and/or programming instructions for further enhancing the personality may be retrieved. The address specifications may be in the form of one or more Uniform Resource Locators (URLs). The interchangeable covering 220 may be placed on the exposed mobile phone 200 to be an integral component forming and personalizing the exposed mobile phone 200, thus allowing the user to easily switch the personalizing theme of phone 100.

From hereon forward (including the claims), for ease of understanding, “data and/or programming instructions” will simply be referred to as “data”. Usage of the term “data” includes “data” as it is conventionally used, and/or “programming instructions”, unless the implicit optional inclusion of “programming instructions” is explicitly excluded.

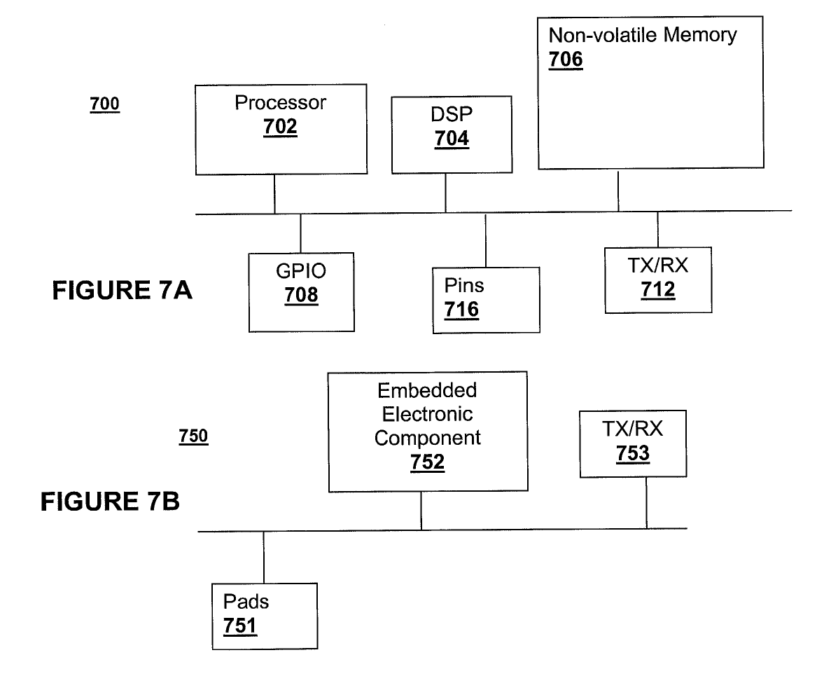

In order to facilitate exchange of data between the mobile phone 200 and the interchangeable covering 220 (after they have engaged each other), a coupler in the form of contact pins 221 is shown configured to match and engage contact pads 222 connected to an electronic component 223 embedded in the interchangeable covering 220, in accordance with one embodiment of the invention. This electronic component 223 may be a memory, a processor, or a combination of both. These contact pins 221 may be pins that work in conjunction with contact pads 222 to form an interface, such as, but not limited to, a serial interface. The contact pads 222 may be formed over the embedded electronic component 223, with leads from selected ones of the various components of the embedded electronic component 223, being in connection with the contact pads 222. The embedded electronic component 223 may transfer data to a mobile phone processor 702 (shown in FIG. 7), may receive data from the mobile phone processor 702, and may receive power from the exposed mobile phone 200 such as, but not limited to, a 3 volt supply voltage.

Shown in FIGS. 2A & 2B, the contact pins 221 are on the exposed mobile phone 200, while the contact pads 222 are on the interchangeable covering 220. However, in order to couple the embedded electronic component 223 with the exposed mobile phone 200, the contact pads 222 may be included in the exposed mobile phone 200, while the contact pins 221 may be on the interchangeable covering 220. The exposed mobile phone 200 or the interchangeable covering 220 would not include both the contact pads 222 and the contact pins 221 on the same device/component.

Additionally, in FIG. 2B, the interchangeable covering 220 is shown as substantially similar in shape, length, and width to the exposed mobile phone 200. However, the interchangeable covering 220 may be of any shape and size to cover all or portions of the exposed mobile phone 200, such as, but not limited to, an interchangeable covering that covers only a portion of the exposed mobile phone 200. The interchangeable covering may cover only the face of the exposed mobile phone 200. Additionally, it may cover the sides of the exposed mobile phone or portions thereof. The interchangeable covering may also cover the back of the exposed mobile phone or portions thereof. Further, a mobile phone may not necessarily be an exposed mobile phone, but instead, may be a fully assembled mobile phone that includes coupling capabilities to incorporate the advantages of the present invention. In one embodiment, the interchangeable covering is a molded covering.

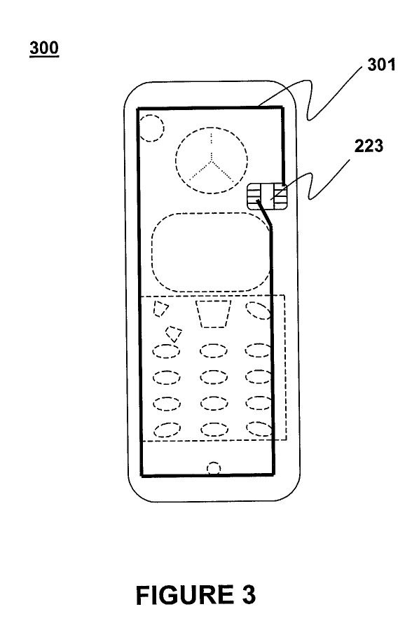

FIG. 3 illustrates an alternate embodiment for integrating an electronic component with interchangeable coverings of mobile electronic devices to personalize the mobile electronic device. Shown in FIG. 3 is an internal view of a contactless interchangeable covering 300. The contactless interchangeable covering 300 has a number of turns of a conductive material 301, such as, a wire thin enough to be embedded in the body of the contactless interchangeable covering 300. The conductive material 300 forms an antenna for data signal transmission and reception, i.e., a contactless coupler. Shown in FIG. 3, the conductive material 301 is turned a number of times around the perimeter of the contactless interchangeable covering 300 to match the shape of the contactless interchangeable covering 300. The shape of the conductive material may be in any form to transmit and receive data via electromagnetic signals, thereby, acting as an antenna. The ends of the conductive material 301 connect to the embedded electronic component 223 within the contactless interchangeable covering 300, and this connection may be made by connecting to contact pads/pins connected to the embedded electronic component 223 to allow for data to be communicated via transmit/receive (shown as ref. 753 in FIG. 7). The conductive material 301 shown may be a thin wire; however, the conductive material 301 shown may also be any type of conductive material, such as, but not limited to, conductive ink. As shown in FIG. 3, the conductive material 301 is connected to the electronic component 223 embedded in the contactless interchangeable covering 300. Since, the contactless interchangeable covering 300 utilizes the conductive material 301 as the antenna for receiving and transmitting data to the mobile phone processor 702, the contact pads and contact pins previously described are not necessary for transmission and reception of data and/or power. In this embodiment, contactless coupling is used to transmit and receive data and/or power between the contactless interchangeable covering and the mobile electronic device.

In the one embodiment shown in FIG. 3, power may be supplied to the embedded electronic component 223 within the contactless interchangeable covering 300 by electromagnetic signals from the mobile electronic device, mobile phone 100. A larger power supply is available from a mobile electronic device because a possible power supply embedded in a contactless interchangeable covering may be limited by size.

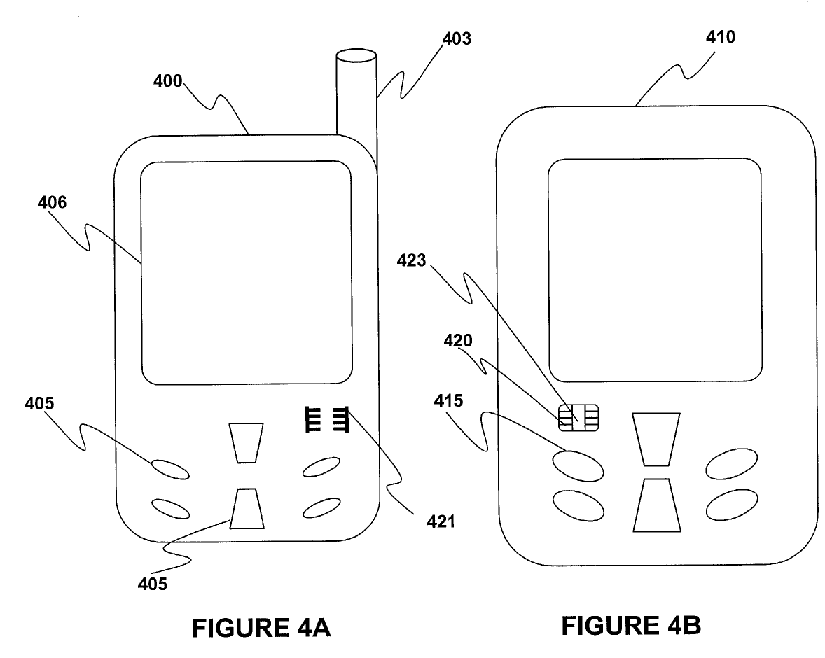

FIGS. 4A & 4B illustrate another example of an electronic device, upon which one embodiment of the invention may be practiced. Shown in FIGS. 4A & 4B, a mobile electronic device, a personal digital assistant (PDA)/handheld personal computer (handheld PC), collectively referred to as a PDA, has its interchangeable PDA covering 410 removed exposing an exposed PDA 400, revealing an internal view of the interchangeable PDA covering 410. In FIGS. 4A are shown various buttons 405 for activating certain functions, such as, but not limited to, scrolling through displayed information, an LCD 406 to display the information and form a graphical interface, and, optionally, an antenna 403 to receive and transmit data from the exposed PDA 400. Shown on the interchangeable PDA covering 410, are various openings 415 to allow the various buttons 405 to be pressed through the interchangeable PDA covering 410.

The embodiment shown in FIGS. 4A & 4B also includes contact pads 420 on the interchangeable PDA covering 410 and contact pins 421 on the PDA 400. As previously described, the contact pads 420 and the contact pins 421 allow for personalization of the PDA 400 by utilizing the embedded electronic component 423 (such as memory and/or processor) embedded behind the contact pads 420 on the interchangeable PDA covering 410.

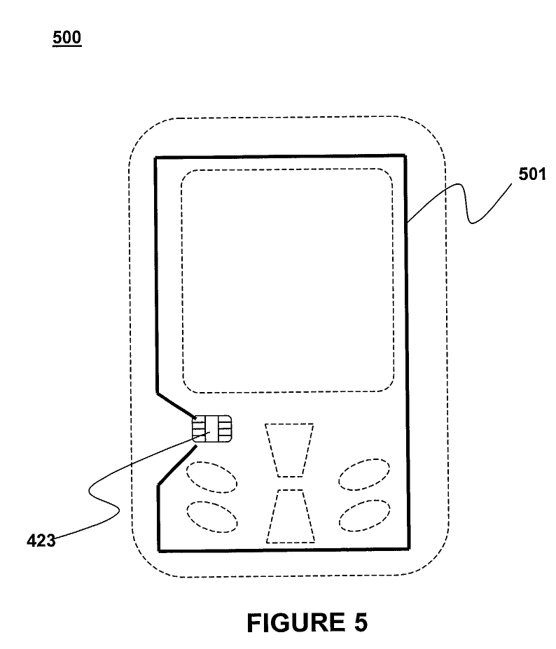

FIG. 5 illustrates an internal view of a contactless interchangeable PDA covering 500 for the PDA 400. As previously described with respect to the mobile phone 100, the contactless interchangeable PDA covering 500 has a number of turns of a conductive material 501, such as a wire thin enough to be embedded in the body of the contactless interchangeable PDA covering 500, forming an antenna for signal transmission and reception. Also, the conductive material 501 may be of any type of conductive material, such as, but not limited to, conductive ink. Here again, the conductive material 501 is turned a number of times around the perimeter of the contactless interchangeable PDA covering 500. The windings of the conductive material 501 of the contactless interchangeable PDA covering 500 form a contactless coupler facilitating exchange of data between the embedded electronic component 423 and the PDA 400. Additionally, power may be supplied to the embedded electronic component 423 within the contactless interchangeable PDA covering 500 by electromagnetic signals from the mobile electronic device, the PDA 400.

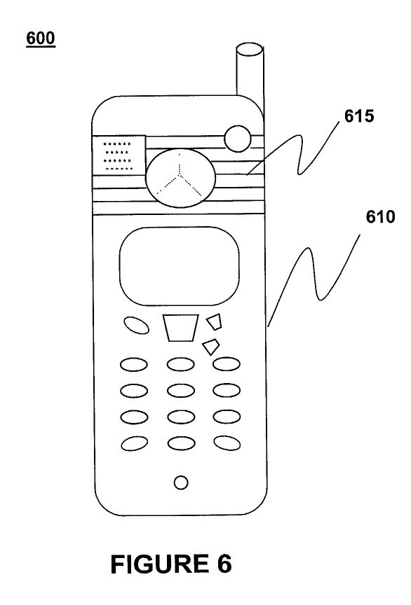

FIG. 6 illustrates an example of personalizing an electronic device, in accordance with one embodiment of the invention. As shown in FIG. 6, a mobile electronic device, such as, a mobile phone 600, has an interchangeable covering 610 attached. The interchangeable covering 610 includes a theme, such as, but not limited to, an American theme, where the theme includes visual representations as well as audio representations. The visual representations may include e.g. an American flag 615 imprinted on interchangeable covering 610. Additionally, a processor 702 (FIG. 7) of the mobile phone 600 exchanges other audio/visual related data with an electronic component 752 embedded in the interchangeable covering 610. The embedded electronic component 752 has audio/visual data, as earlier described for embedded electronic components 223 & 423, allowing the user to switch the personality of the mobile phone 600. The audio/visual data can include, for example, a customizing ring tone complementary to the American theme.

For example, the processor 702 of the mobile phone 600, may receive audio/visual data from the embedded electronic component 223 & 423 within the interchangeable covering 610 to provide a variety of American flag oriented functions for the mobile phone 600, such as, but not limited to, a ring option that plays the “Star Spangled Banner”, games that include learning the capitals of the 50 states, a screen saver in the form of a waving American flag, and/or a modification to the default voice mail greeting.

In another example, a user may require the appearance of the mobile phone to be subtle and professional during the business hours. Accordingly, a factory standard covering without personalizing themes is used during business hours. At the end of the business hours, the user may attend a sporting event of his/her favorite sports team. In order to support his/her particular team, the user may change the interchangeable covering to one with the team logo. Moreover, the data stored in the embedded electronic component of the interchangeable covering provide various non-visual manifestations, such as behavioral and/or audio manifestations, that are related to the team. For example, the audio manifestation may include the team song as the ring tone, and so forth.

In one embodiment, the interchangeable covering may incorporate both the contactless and the contact coupling configurations, i.e., an interchangeable covering having both windings of conductive material functioning as an antenna and contact pads exposed on the inside surface of the interchangeable covering. The interchangeable covering incorporating both the contactless and the contact coupling configurations may include data stored in an embedded electronic component to detect if a physical coupling has occurred. If a physical coupling is detected, the data would be transferred through the physical coupling. However, if a physical coupling is not detected, the programming logic may await a wireless signal from a mobile electronic device to initialize a wireless coupling.

In one embodiment, the interchangeable covering of the present invention having a thematic appearance and complementary embedded electronic component may be in the form of an interchangeable skin. A skin is a thin flexible material in the form of a membrane, such as an elastomeric membrane, which may be molded to cover a mobile electronic device. This skin would add a personalized visual as well as non-visual touch to the mobile electronic device. The skin may be available in various thematic colors and designs, and the embedded electronic component in the interchangeable skin includes thematic data that corresponds to the particular thematic colors and designs of the skin. Additionally, the skin may be of the non-molded type, whereby, the skin fits loosely on the mobile electronic device, such as, a loosely fitting waterproof enclosure. The interchangeable covering in the form of a waterproof enclosure may have an electronic component embedded within that is capable of causing a ring tone that sounds like e.g. a fog horn.

In an alternate embodiment, the interchangeable covering may be in the form of an interchangeable rigid covering, such as, but not limited to, a faceplate. That is, a hard material covering a mobile electronic device in the form of a snap-on type covering. This interchangeable rigid covering may be of the molded type.

The electronic component embedded within an interchangeable covering of a mobile electronic device might also include a variety of different data corresponding to multiple themes for selection. The visual design of such interchangeable covering would be a generic design suitable for the collection of themes included. These themes may include, for example, proprietary themes, owned by multiple proprietors or their licensees. Examples of proprietary themes include “Hello Kitty” theme of Sanrio Company, Ltd., Tokyo, Japan, and “Pokemon” theme of Nintendo Company, Ltd., Kyoto, Japan.

Further, the electronic component embedded in an interchangeable covering may include data for providing screen savers for various advertisers, various fonts to match various themes, various resource server specifications for various themes, and various phone numbers corresponding to various themes. The screen savers may be camouflage that blends with the design of covering. The resource server specifications may be used to contact a resource server for additional functionalities and/or contents. The resource specifications may be in the form of Uniform Resource Locators (URLs). In other embodiments, the data may include an identifier of the covering, and/or an approval code, both of which may be employed to facilitate access to the additional personalization functionalities and/or contents.

Optionally, in one embodiment, an interchangeable covering may further include light emitting diodes (LEDs) with included data controlling the LEDs. These LEDs may be utilized for various visual activities, such as, but not limited to, displaying a message, or lighting up corresponding to sounds.

The electronic component embedded in the interchangeable covering may also include names, phone numbers, resource server specifications, and email addresses, for use in wireless communication. When connected to the mobile phone, the names, phone numbers, resource server specifications, and email addresses may be inserted into a phone list contained within the mobile phone. The embedded electronic component may further contain audio content, such as music, which can be played on an audio player within the mobile phone. The audio content may be a form of an audio data file, such as, but not limited to, a moving pictures expert group (MPEG) audio layer 3 (MP3) data file, an MPEG-4 Structured Audio data file and so forth. The audio player may be in the form of instructions stored in non-volatile memory of the mobile phone/PDA or the embedded electronic component of the interchangeable covering to process audio data file and convert it into audio. Additionally, the embedded electronic component may contain other media content, such as, but not limited to, animation and/or video.

The embedded electronic component may also contain data for setting the voice that is used for voice messaging. This voice may be a prerecorded voice that provides instructions for retrieving voice messages. It may also be a prerecorded voice that answers the phone when the user does not answer the phone. The data for setting the voice may include the actual recordings. Alternatively, the data may include information that identifies voice recordings stored at a wireless provider's computer. When the actual recordings are stored at a wireless provider's computer, initialization of the settings includes sending a signal to the wireless provider indicating the selection of a prerecorded voice to use. The data may also include information that identifies voice recordings stored at an Internet service provider's computer, together with an address, such as resource server specifications, for locating the voice recording. During initialization of settings, this information is transmitted to the Internet service provider.

FIGS. 7A & 7B illustrate an architectural view of an electronic device 700, which is intended to be representative of mobile phone 100 and PDA 500, and an interchangeable covering 750, which is to be representative of the interchangeable covering 220. The interchangeable covering includes an electronic component 752 embedded in the interchangeable covering 750, which is to be representative of the embedded electronic components 223 & 423, in accordance with one embodiment of the invention. As previously described, the embedded electronic component 752 may be a memory, a CPU, or a combination of both.

As illustrated, mobile electronic device 700 includes elements found in conventional mobile electronic devices, such as processor 702, digital signal processor (DSP) 704, non-volatile embedded memory 706, general-purpose input/output (GPIO) interface 708, and transmit/receive (TX/RX) 712. For the illustrated embodiment, mobile electronic device 700 also advantageously includes contact pins 716 to facilitate transfer of data to and from the electronic component 752 embedded in the interchangeable covering 750. Additionally, the interchangeable covering 750 includes contact pads 751 to form an interface with the contact pins 716. Optionally, non-volatile memory 706 may include instructions to decompress MPx data files (where MPx stands for any one of the MPEG standards), and these instructions to be executed by the processor 702 facilitating an audio player. In alternate embodiments, mobile electronic devices 700 may also include other components, such as an embedded radio.

Alternatively, as discussed above, if the interchangeable covering 750 is a contactless interchangeable covering, the processor device 702 receives and transmits data to the embedded electronic component 752 via the TX/RX 712. The receiving and transmitting is facilitated by the conductive material 301 (shown in FIG. 3) included in the mobile electronic device 700 and a complementary TX/RX 753 included in the interchangeable covering 750.

The electronic component 752 embedded in the interchangeable covering 750 may be a random access memory (RAM), an electrically erasable programmable read only embedded memory (EEPROM), read only embedded memory (ROM), a central processing unit (CPU), a subscriber identity module (SIM) smart card, or a combination thereof. The capabilities of components may be 1 Kilobyte of RAM, 16 Kilobytes of EEPROM, 24 Kilobytes of ROM, and an 8-bit microprocessor running at 5 Megahertz as the CPU. Because of the variety of components available as the electronic component 752 embedded in the interchangeable covering 750, in one embodiment, the processor 702 may write and store data into the electronic component 752 embedded in the interchangeable covering 750. For example, the processor may store certain telephone numbers in the embedded electronic component of interchangeable covering. If the electronic component 752 embedded in the interchangeable covering 750 is utilized to store certain type of data requiring security, the embedded electronic component 752 may be in the form of a CPU to process security instructions.

In one embodiment, embedded electronic component 752 may also include data to provide electronic coupons that allow a user of the wireless mobile electronic device to obtain discounts on purchases of items or services. The items or services may be related to the personalizing theme of the interchangeable covering, or related to the business of advertisers or sponsors of the interchangeable covering.

In one embodiment, embedded electronic component 752 may also include data to implement a font complementing the personalizing theme of the interchangeable covering. The font may correspond to personalizing themes, such as, but not limited to, an alien font from a science fiction series, and so forth.

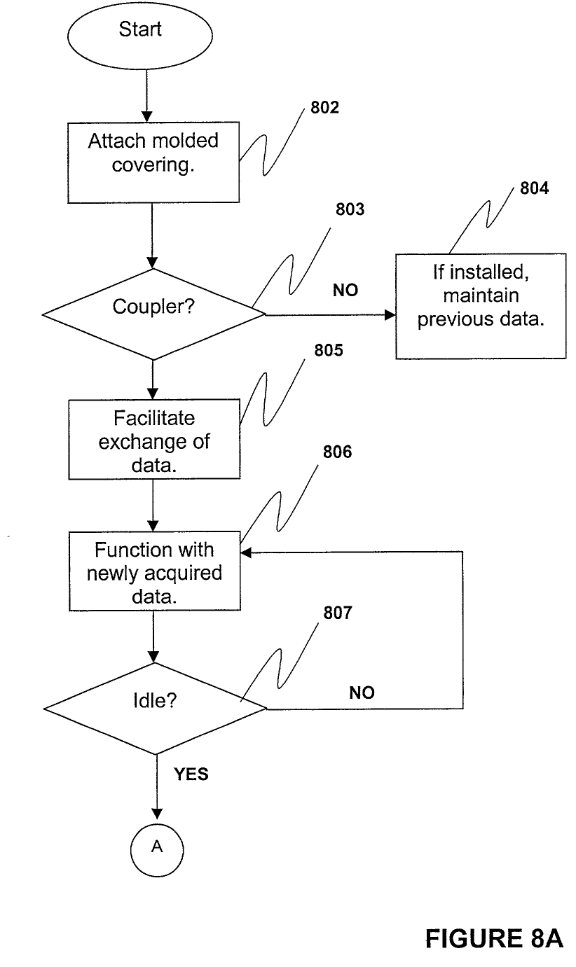

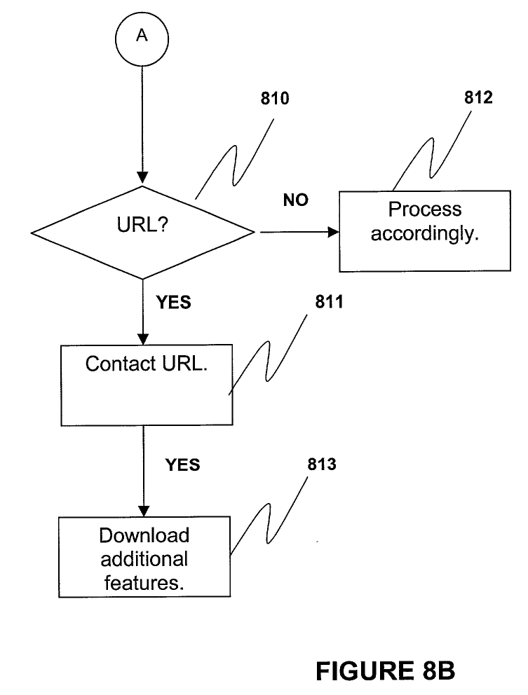

FIGS. 8A & 8B illustrate the operational flow of the relevant aspects of the enhanced main logic of phone/PDA to take advantage of improved interchangeable coverings with embedded personality for mobile electronic devices, in accordance with one embodiment of the invention. As illustrated in FIG. 8A, an interchangeable covering is attached onto a mobile electronic device, such as the previously described mobile phone and PDA 802. In the process of initialization, the main logic checks for the presence of the interchangeable covering with embedded personalizing theme. The main logic determines whether the contacts of the mobile electronic device are in contact with the “contacts” of the interchangeable covering 803. The “in contact” condition may be discerned, for example, by attaching a pull-up device to the mobile electronic device's contact, and contact with the interchangeable covering's contact causes a pull-down effect. The main logic determines whether contact is made based on whether a signal is in a high (pull-up) or a low (pull-down) state. As previously described, the coupler may be of a contact or a contactless type.

Once it is determined that contacts of the mobile electronic device are in contact with the “contacts” of the interchangeable covering, an exchange of data between the interchangeable covering and the mobile electronic device is facilitated 805. The exchange of data is made between a processor included in the mobile electronic device and an embedded electronic component within the interchangeable covering. During this exchange of data, settings, such as, but not limited to, a customizing ring tone complementary to the personalizing theme of the interchangeable covering is immediately implemented in the mobile electronic device. Additionally, during the exchange of data, a resource server specification is exchanged. This resource server specification may be utilized to contact a resource server. The mobile electronic device functions with the newly acquired data 806, i.e., mobile electronic device will ring in the customizing tone when receiving a subsequent call.

Once the mobile electronic device is functional with the newly acquired data with the settings in place, the main logic determines if an “idle” opportunity is available 807, and this “idle” opportunity may be a predetermined period when the usage of the mobile electronic device is minimal. However, if there is no coupling between the interchangeable covering and the mobile electronic device, the mobile electronic device may maintain a previously installed data complementing a previous personalizing theme until a presence of an interchangeable covering with embedded personalizing theme is detected 804.

Referring now to FIG. 8B, if an “idle” opportunity is available, the main logic determines if the resource server specification is in the form of an URL 810. If the resource server specification is in the form of an URL, the processing of the URL involves contacting a resource server containing data related to personalization 811. Once the resource server is contacted, the main logic may wirelessly access the resource server, and acquire additional data to further complement the personalizing theme 813. However, if the retrieved data is not in the form of an URL, the main logic processes accordingly the retrieved data 812.

Furthermore, if no contact data is available from the embedded electronic component, the main logic continues to function with the acquired data 806 (shown in FIG. 8A).

Accordingly, an interchangeable covering with embedded personality for an electronic device having capabilities to facilitate easy and user-friendly acquisition of personalization of the electronic device has been described. While the invention has been described in terms of the above-illustrated embodiments, one skilled in the art will recognize that the invention is not limited to the embodiments described. The invention can be practiced with modification and alteration within the spirit and scope of the appended claims. For example, the present invention may be practiced with options to allow a user to accept or reject all or a portion of the additional functionalities and/or content to be added to the base electronic device, as result of the engagement of the “smart” interchangeable covering. Another example is in some embodiments, in lieu of the employment of an electronic component, a bar code or a magnetic stripe having certain identification information be used instead to “couple” to the base electronic device (having complementary bar code or magnetic stripe “reader” capability), the type and/or location of the additional functionalities and/or contents. Another example is the inclusion of certain anti-piracy features, such as upon installation of the added functionalities and/or contents, the same combination of interchangeable cover and base electronic device is required for the installed additional functionalities and/or content to be available and/or useable. Thus, the description is to be regarded as illustrative instead of restrictive on the invention.

What is claimed is:

1. An apparatus comprising:
an electronic device;
an interchangeable covering designed to at least partially cover the electronic device, including an electronic component embedded within the interchangeable covering, the electronic component having data encoded thereon; and
a coupler to facilitate exchange of said data between the electronic device and the embedded electronic component in the interchangeable covering.

2. The apparatus of claim 1, wherein the electronic device is a selected one from an electronic device group comprising at least one of a mobile phone, a personal digital assistant, a handheld personal computer, a media player and a game console.

3. The apparatus of claim 1, wherein the interchangeable covering is a selected one from a covering group comprising at least one of an interchangeable rigid faceplate and an interchangeable skin, each having a surface design to be complemented by personalization resulted from said exchange of data.

4. The apparatus of claim 1, wherein the electronic component embedded within the interchangeable covering is a selected one from a component group comprising at least one of a central processing unit (CPU), a random access memory (RAM), a read only memory (ROM), a subscriber identity module (SIM) smart card, and an electrically erasable programmable read only memory (EEPROM).

5. The apparatus of claim 1, wherein the coupler comprises a contact coupler.

6. The apparatus of claim 5 further comprising:
a plurality of contact pads coupled to the electronic component embedded within the interchangeable covering; and
a plurality of contact pins included in the mobile electronic device to facilitate transfer of data to and from the mobile electronic device and the electronic component embedded within the interchangeable covering.

7. The apparatus of claim 1, wherein the coupler comprises a contactless coupler.

8. The apparatus of claim 7 further comprising a winding of a conductive material coupled to the electronic component embedded within the interchangeable covering, the winding embedded within the interchangeable covering.

9. The apparatus of claim 1, wherein the data exchanged comprises at least one of a name, a phone number, a resource server specification, an email address, an electronic coupon, a font style, an identifier of the covering, an approval code, and executable code implementing an additional function.

10. The apparatus of claim 1, wherein the data exchanged comprises an audio data file.

11. The apparatus of claim 1, wherein the data exchanged comprises a media file.

12. The apparatus of claim 1, wherein the data exchanged comprises data for setting a voice utilized for messaging functions.

13. An apparatus comprising:
a cover to cover an electronic device; and
an electronic component embedded within the cover, the electronic component including
a medium encoded with data, and
an interface to facilitate provision of said data to the covered electronic device.

14. The apparatus of claim 13, wherein the electronic device is an electronic device selected from a group comprising at least one of a mobile phone, a personal digital assistant, a handheld personal computer, a media player and a game console.

15. The apparatus of claim 13, wherein the cover is a covering selected from a covering group comprising at least one of an interchangeable rigid faceplate and an interchangeable skin, each having a surface design to be complemented by personalization resulted by said provision of the encoded data to the electronic device.

16. The apparatus of claim 13, wherein the electronic component embedded within the cover is a selected one from a component group comprising at least one of a central processing unit (CPU), a random access memory (RAM), a read only memory (ROM), a subscriber identity module (SIM) smart card, and an electrically erasable programmable read only memory (EEPROM).

17. The apparatus of claim 13, wherein the interface comprises a selected one of a contact coupler and a contactless coupler.

18. The apparatus of claim 17 wherein in the case of a contact coupler, the interface further comprises a plurality of contact pads.

19. The apparatus of claim 13, wherein the medium comprises a selected one of a bar code and a magnetic stripe.

20. The apparatus of claim 19 the interface comprises a corresponding selected one a bar code reader and a magnetic stripe reader.

21. The apparatus of claim 13, wherein the data comprises at least one of a name, a phone number, a resource server specification, an email address, an electronic coupon, a font style, an identifier of the covering, an approval code, and executable code implementing an additional function.

22. The apparatus of claim 13, wherein the data comprises an audio data file.

23. The apparatus of claim 13, wherein the data comprises a compressed media file.

24. The apparatus of claim 13, wherein the data comprises data for setting a voice utilized messaging functions.

25. A method comprising:
facilitating an exchange of data between an interchangeable covering, having an embedded electronic component, and an electronic device, the data being stored in said embedded electronic component; and
executing instructions in the electronic device based on the exchanged data.

26. The method of claim 25, wherein said facilitating comprises determining if the interchangeable covering has data to be exchanged.

27. The method of claim 25, wherein said executing comprises initializing a selected one of personalizing data and additional function in the electronic device.

28. The method of claim 25 further comprising:
determining whether the electronic device is idle;
if the electronic device is idle, contacting a resource server containing at least a selected one of personalizing data and additional function; and
receiving at least a selected one of one or more additional personalizing data and additional function from the resource server.

29. The method of claim 25 further comprising:
receiving a resource server specification from the interchangeable covering; and
using the resource server specification to contact a resource server.

30. The method of claim 29, wherein the resource server specification comprises a Uniform Resource Locator (URL).

31. The method of claim 25, wherein facilitating comprises determining if contact is formed between the electronic device and the interchangeable covering.

32. The method of claim 31, wherein determining if contact is formed comprises determining if contacts of the electronic device are in physical contact with contacts of the interchangeable covering.

33. The method of claim 25, wherein the interchangeable covering is a selected one from a covering group comprising at least one of an interchangeable rigid faceplate and an interchangeable skin, each having a surface design to be complemented by personalization resulted from said exchange of data.

34. The method of claim 25, wherein facilitating comprises determining if a contact coupler is present.

35. The method of claim 25, wherein facilitating comprises determining if a contactless coupler is present.

36. The method of claim 25, wherein executing comprises initializing a ring tone corresponding to the exchanged data.

37. The method of claim 25, wherein facilitating exchange of data comprises facilitating exchange of a selected one of personalizing related data and additional function with a microprocessor/storage chip embedded in the interchangeable covering.

38. The method of claim 37, wherein said microprocessor/storage chip is a selected one from an electronic component group comprising at least one or more of a central processing unit (CPU), a random access memory (RAM), a read only memory (ROM), a subscriber identity module (SIM) smart card, and an electrically erasable programmable read only memory (EEPROM).

39. An article comprising
a machine accessible medium having instructions encoded therein, the instructions, when executed on an electronic device, facilitate an exchange of data between an interchangeable covering, having an embedded electronic component containing the exchanged data, and the electronic device, and thereafter, tailor the execution of the instructions on the electronic device based on the exchanged data.

40. The article of claim 39, wherein the electronic device is an electronic device selected from a group comprising at least one of a mobile phone, a personal digital assistant, a handheld personal computer, a media player and a game console.

41. The article of claim 39, wherein the data exchanged comprises at least one of a name, a phone number, a resource server specification, an email address, an electronic coupon, a font style, an identifier of the covering, an approval code and executable instructions implementing additional function.

42. The article of claim 41, wherein the data exchanged comprises an audio data file.

43. The article of claim 39, wherein the interchangeable covering is a selected one from a covering group comprising at least one of an interchangeable rigid faceplate and an interchangeable skin, each having a surface design to be complemented by personalization resulted said exchange of data.

44. The article of claim 39, wherein the electronic device is a telephony related device, and the data exchanged comprises data for setting a voice utilized for messaging functions.

45. The article of claim 39, wherein the electronic device is a wireless mobile phone, and said instructions, when executed, initialize a ring tone corresponding to the exchanged data.

46. An apparatus comprising:
cover means to cover an electronic device; and
data provision means embedded within the cover, the data provision means including
medium means encoded with data, and
interface means to facilitate provision of said data to the covered electronic device.

47. The apparatus of claim 46, wherein said cover means is a covering selected from a covering group comprising at least one of an interchangeable rigid faceplate and an interchangeable skin, each having a surface design to be complemented by personalization resulted by said provision of the encoded data to the electronic device.

48. The apparatus of claim 46, wherein the data provision means embedded within the cover means is a selected one from a component group comprising at least one of a central processing unit (CPU), a random access memory (RAM), a read only memory (ROM), a subscriber identity module (SIM) smart card, and an electrically erasable programmable read only memory (EEPROM).

49. The apparatus of claim 46, wherein the interface means comprises a selected one of a contact coupler and a contactless coupler.

50. The apparatus of claim 46, wherein the data comprises at least one of a name, a phone number, a resource server specification, an email address, an electronic coupon, a font style, an identifier of the covering, an approval code, and executable code implementing an additional function.

51. The apparatus of claim 46, wherein the data comprises a selected one of an audio data file, a compressed media file and a voice utilized messaging function.

52. An electronic device comprising:
first electronic components;
a body encasing the first electronic components, the body having physical attributes designed to facilitate reception of a cover to cover the body; and
an interface disposed on said body designed to mate with an interface of a second electronic component embedded within said cover, to facilitate receipt of data encoded in a medium of said second embedded electronic component.

53. The electronic device of claim 52, wherein said cover is a covering selected from a covering group comprising at least one of an interchangeable rigid faceplate and an interchangeable skin, each having a surface design to be complemented by personalization resulted by said provision of the encoded data to the electronic device.

54. The electronic device of claim 52, wherein said second electronic component embedded within the cover is a selected one from a component group comprising at least one of a central processing unit (CPU), a random access memory (RAM), a read only memory (ROM), a subscriber identity module (SIM) smart card, and an electrically erasable programmable read only memory (EEPROM).

55. The electronic device of claim 52, wherein the interface comprises a selected one of a contact coupler and a contactless coupler.

56. The electronic device of claim 52, wherein the data comprises at least one of a name, a phone number, a resource server specification, an email address, an electronic coupon, a font style, an identifier of the covering, an approval code, and executable code implementing an additional function.

57. The electronic device of claim 52, wherein the data comprises a selected one of an audio data file, a compressed media file and a voice utilized messaging function.

58. The electronic device of claim 52, wherein the electronic device is a mobile communication device.

59. The electronic device of claim 58, wherein the mobile communication device is a wireless mobile phone.
